(19) United States
(12) Patent Application Publication
(10) Pub. No.: US 2020/0153561 A1
(43) Pub. Date: May 14, 2020

(54) FLEXIBLE RETRANSMISSION-PROCESS BUFFER MANAGEMENT

(71) Applicant: NOKIA TECHNOLOGIES OY, Espoo (FI)

(72) Inventors: Saeed Reza Khosravirad, Wroclaw (PL); Klaus Ingemann Pedersen, Aalborg (DK); Jens Steiner, Klarup (DK)

(21) Appl. No.: 16/614,348

(22) PCT Filed: May 16, 2017
(86) PCT No.: PCT/EP2017/061700

§ 371 Date: Nov. 15, 2019

(51) Int. Cl. H04L 1/18; H04W 72/04

(52) U.S. Cl. CPC H04L 1/1835; H04W 72/04

(57) ABSTRACT

There are provided measures for flexible retransmission-process buffer management, such as e.g. flexible HARQ process buffer management, in the context of re-/transmission of a radio resource block composed of a plurality of resource block parts. Such measures exemplarily comprise buffer management and buffer management control, wherein a buffer element is flexibly managed by selectively discarding and keeping buffered soft data information of a transmitted radio resource block per resource block part based on decoding performance information for the buffered soft data information of the transmitted radio resource block prior to combining, per resource block part, soft data information of a retransmitted radio resource block with buffered soft data information of the transmitted radio resource block for decoding the radio resource block.

### FIELD

The present invention relates to flexible retransmission-process buffer management, such as e.g. flexible HARQ process buffer management, in the context of re-/transmission of a radio resource block composed of a plurality of resource block parts.

### BACKGROUND

The present disclosure generally relates to telecommunication technologies where retransmission techniques such as HARQ are deployed to ensure or increase channel reliability and/or average aggregated throughput. The present disclosure is thus applicable for any such telecommunication technologies, including e.g. the emerging 5G technology (including 5G New Radio) as well as the current and evolving LTE, Wi-Fi and other wireless technologies where retransmission techniques such as HARQ are used.

In the present disclosure, HARQ is referenced as a non-limiting example of a hybrid-type retransmission technique, in which ARQ-based error control and forward error correction are combined. More specifically, the present disclosure refers to HARQ with soft combining, in which an incorrectly received coded data block is stored at the receiver rather than discarded and, when the re-transmitted coded data block is received, the two blocks are combined for decoding the coded data block in a more reliable manner.

At the receiver, a HARQ buffer is utilized for storing the soft bits of an initially failed packet (wherein the term “soft bit” refers to a value for a data bit, which is not 0 or 1 but reflects an interference/decoding-related measure thereof resulting from its transmission) to exploit combining gain after the arrival of a retransmission for the same packet. To this end, the retransmission of an already transmitted packet has to be identified as such. In typical wireless technologies, such as LTE, a new data indicator (NDI) is used in the control signaling, which indicates whether a transmission is an initial transmission or a retransmission of the same packet. The NDI is normally a single-bit control signal which is toggled when the transmission is an initial attempt for a new packet and is kept the same if the transmission is a retransmission of a previously transmitted packet. The message or indication of an NDI-toggling for the receiver is to completely flush the HARQ buffer, i.e. discard or delete the complete contents thereof, for the respective HARQ process and store the newly received packet or, specifically, the soft bits thereof.

The HARQ buffer associated to a transport block (TB) with multiple code blocks or code block (CB) segments, i.e. a radio resource block composed of a plurality of resource block parts, stores the soft bits corresponding to each CB separately and, after receiving a potential retransmission, combining as well as decoding takes place separately per CB. Therefore, the single-bit NDI will cause simultaneously flushing (in case of toggled NDI) or keeping (in case of non-toggled NDI) the HARQ buffers corresponding to all of a plurality of CB's in a large TB.

There is a problem that an error as an effect of severe interference (in the form of a dynamic and/or semi-static interference or a transmission interruption, also known as puncturing or preemptive scheduling, e.g. due to sudden low-latency critical data for other UEs, also known as URLLC traffic) can potentially propagate through the HARQ process. For example, this problem arises when the initial transmission of a packet is fully or partly hit by severe interference, leading to a failure in the first round of decoding and the request for retransmission, and the effect of such interference will be passed on to the second round of decoding after HARQ retransmission by means of combining (the newly received soft bits of) the retransmitted packet with (the buffered soft bits of) the interfered initially transmitted packet. The effect of such error propagation is a reduced performance for packets which consequently will result in reduced throughput as well as packet delivery latency.

Such a problem can be resolved when the entire HARQ buffer of a given TB is identified as ‘hurtful’ to the combining/decoding process and thus completely flushed, e.g. by toggling the single-bit NDI in the retransmission DCI. This is, however, not efficient especially in case of a large TB composed of multiple CB's where each CB could potentially have experienced dramatically different interference levels. Namely, by such approach, valuable knowledge for the combining/decoding process would be lost, and the desired combining gain cannot be sufficiently exploited.

In view of the above, it is evident that retransmission control on the basis of the known single-bit NDI is inefficient in the context of re-/transmission of a radio resource block composed of a plurality of resource block parts, which is basically due to a lack of flexibility in retransmission control and an associated lack of flexibility in buffer management.

Accordingly, there is a demand for enabling/realizing flexible retransmission-process buffer management, such as e.g. flexible HARQ process buffer management, in the context of re-/transmission of a radio resource block composed of a plurality of resource block parts.

### SUMMARY

Various exemplifying embodiments of the present invention aim at addressing at least part of the above issues and/or problems and drawbacks.

Various aspects of exemplifying embodiments of the present invention are set out in the appended claims.

According to an example aspect of the present invention, there is provided a method, comprising buffering, in a buffer element, soft data information of a transmitted radio resource block composed of a plurality of resource block parts per resource block part if retransmission of the transmitted radio resource block is requested for decoding the radio resource block, acquiring decoding performance information for the buffered soft data information of the transmitted radio resource block per resource block part, and selectively discarding and keeping, in the buffer element, the buffered soft data information of the transmitted radio resource block per resource block part based on the acquired decoding performance information prior to combining, per resource block part, soft data information of the retransmitted radio resource block with buffered soft data information of the transmitted radio resource block for decoding the radio resource block.

According to an example aspect of the present invention, there is provided a method comprising collecting information indicative of decoding performance of soft data information of a transmitted radio resource block composed of a plurality of resource block parts per resource block part, which is buffered in a buffer element, if retransmission of the transmitted radio resource block is requested for decoding the radio resource block, deriving a buffer management decision on the basis of the collected information, said buffer management decision defining, per resource block part, the resource block parts for which the buffered soft data information of the transmitted radio resource block is to be respectively discarded or kept in the buffer element prior to combining, per resource block part, soft data information of the re-transmitted radio resource block with buffered soft data information of the transmitted radio resource block for decoding the radio resource block, and controlling management of the buffer element on the basis of the derived buffer management decision.

According to an example aspect of the present invention, there is provided an apparatus comprising at least one processor and at least one memory including a computer program code, wherein the at least one memory and the computer program code are configured, with the at least one processor, to cause the apparatus to perform at least the following: buffering, in a buffer element, soft data information of a transmitted radio resource block composed of a plurality of resource block parts per resource block part if retransmission of the transmitted radio resource block is requested for decoding the radio resource block, acquiring decoding performance information for the buffered soft data information of the transmitted radio resource block per resource block part, and selectively discarding and keeping, in the buffer element, the buffered soft data information of the transmitted radio resource block per resource block part based on the acquired decoding performance information prior to combining, per resource block part, soft data information of the retransmitted radio resource block with buffered soft data information of the transmitted radio resource block for decoding the radio resource block.

According to an example aspect of the present invention, there is provided an apparatus comprising at least one processor and at least one memory including a computer program code, wherein the at least one memory and the computer program code are configured, with the at least one processor, to cause the apparatus to perform at least the following: collecting information indicative of decoding performance of soft data information of a transmitted radio resource block composed of a plurality of resource block parts per resource block part, which is buffered in a buffer element, if retransmission of the transmitted radio resource block is requested for decoding the radio resource block, deriving a buffer management decision on the basis of the collected information, said buffer management decision defining, per resource block part, the resource block parts for which the buffered soft data information of the transmitted radio resource block is to be respectively discarded or kept in the buffer element prior to combining, per resource block part, soft data information of the re-transmitted radio resource block with buffered soft data information of the transmitted radio resource block for decoding the radio resource block, and controlling management of the buffer element on the basis of the derived buffer management decision.

According to an example aspect of the present invention, there is provided a computer program product comprising (computer-executable) computer program code which, when the program code is executed (or run) on a computer or the program is run on a computer (e.g. a computer of an apparatus according to any one of the aforementioned apparatus-related example aspects of the present invention), is configured to cause the computer to carry out the method according to any one of the aforementioned method-related example aspects of the present invention.

The computer program product may comprise or may be embodied as a (tangible/non-transitory) computer-readable (storage) medium or the like, on which the computer-executable computer program code is stored, and/or the program is directly loadable into an internal memory of the computer or a processor thereof.

Further developments and/or modifications of the aforementioned exemplary aspects of the present invention are set out in the following.

By way of exemplifying embodiments of the present invention, flexible retransmission-process buffer management, such as e.g. flexible HARQ process buffer management, can be enabled/realized in the context of re-/transmission

of a radio resource block composed of a plurality of resource block parts. That is, in a scenario of re-/transmission of a radio resource block composed of a plurality of resource block parts, it is beneficially possible to increase the flexibility of the retransmission process so that buffered soft data information buffer per resource block part will be used in the combining/decoding process only if the buffer content is determined as ‘useful’ to the decoding performance and will be discarded for the combining/decoding process if the buffer content is determined as ‘hurtful’ to the decoding performance.

### BRIEF DESCRIPTION OF THE DRAWINGS

In the following, the present invention will be described in greater detail by way of non-limiting examples with reference to the accompanying drawings, in which

FIG. 1 shows a flowchart illustrating examples of procedures for buffer management and buffer management control according to exemplifying embodiments of the present invention,

FIG. 2 shows a schematic diagram illustrating a radio resource block and an effect of localized interference on respective resource block parts of the radio resource block according to exemplifying embodiments of the present invention,

FIG. 3 shows a flow diagram illustrating an example of a procedural sequence in an exemplary DL use case according to exemplifying embodiments of the present invention,

FIG. 4 shows a flow diagram illustrating another example of a procedural sequence in an exemplary DL use case according to exemplifying embodiments of the present invention,

FIG. 5 shows a flow diagram illustrating an example of a procedural sequence in an exemplary UL use case according to exemplifying embodiments of the present invention,

FIG. 6 shows a schematic diagram illustrating an example of a structure of apparatuses according to exemplifying embodiments of the present invention, and

FIG. 7 shows a schematic diagram illustrating another example of a functional structure of apparatuses according to exemplifying embodiments of the present invention.

### DETAILED DESCRIPTION

The present invention is described herein with reference to particular non-limiting examples and to what are presently considered to be conceivable embodiments of the present invention. A person skilled in the art will appreciate that the present invention is by no means limited to these examples and embodiments, and may be more broadly applied. It is to be noted that the following description of the present invention and its embodiments mainly refers to specifications being used as non-limiting examples for certain exemplifying network configurations and system deployments. Namely, the present invention and its embodiments are mainly described in relation to 3GPP specifications being used as non-limiting examples. As such, the description of exemplifying embodiments given herein specifically refers to terminology which is directly related thereto. Such terminology is only used in the context of the presented non-limiting examples and embodiments, and does naturally not limit the invention in any way. Rather, any other system configuration or deployment may equally be utilized as long as complying with what is described herein and/or exemplifying embodiments described herein are applicable to it.

Hereinafter, various exemplifying embodiments and implementations of the present invention and its aspects are described using several variants and/or alternatives. It is generally to be noted that, according to certain needs and constraints, all of the described variants and/or alternatives may be provided alone or in any conceivable combination (also including combinations of individual features of the various variants and/or alternatives). In this description, the words “comprising” and “including” should be understood as not limiting the described exemplifying embodiments and implementations to consist of only those features that have been mentioned, and such exemplifying embodiments and implementations may also contain features, structures, units, modules etc. that have not been specifically mentioned.

In the drawings, it is to be noted that lines/arrows interconnecting individual blocks or entities are generally meant to illustrate an operational coupling there-between, which may be a physical and/or logical coupling, which on the one hand is implementation-independent (e.g. wired or wireless) and on the other hand may also comprise an arbitrary number of intermediary functional blocks or entities not shown.

According to exemplifying embodiments of the present invention, in general terms, there are provided measures and mechanisms for enabling/realizing flexible retransmission-process buffer management, such as e.g. flexible HARQ process buffer management, in the context of re-/transmission of a radio resource block composed of a plurality of resource block parts.

As mentioned above, the present disclosure generally relates to telecommunication technologies where retransmission techniques such as HARQ are deployed, wherein HARQ, especially HARQ with soft combining, is referenced as a non-limiting example of a hybrid-type retransmission technique, and addresses the scenario of re-/transmission of a radio resource block, like a transport block (TB), composed of a plurality of resource block parts, like code blocks or code block (CB) segments. Accordingly, a buffering in a buffer (buffer element) generally refers to buffering of soft data information (e.g. soft bits) of a transmitted radio resource block (e.g. a TB) composed of a plurality of resource block parts (e.g. CB's) per resource block part (e.g. CB) if retransmission of the transmitted radio resource block is requested for decoding the radio resource block, i.e. if the initially transmitted radio resource block fails to be properly received and/or decoded.

It is noted that, as outlined below, the retransmitted radio resource block (e.g. a TB) may comprise either all of the resource block parts (e.g. CB's) of the radio resource block or only a subset of the resource block parts (e.g. CB's) of the radio resource block according to a retransmission request.

Although hereinafter, by way of example, reference is mainly made to a code block (CB) of a transport block (TB) as an example of a resource block part of a radio resource block, this is only illustrative but by no means restrictive to the applicability of exemplifying embodiments of the present invention. Generally, any kind of radio resource block and any kind of resource block part thereof can be adopted. For instance, the resource block part my be one of a code block (CB), a group of code blocks (CBG), a time-frequency resource block such as a physical resource block (PRB) or a transmission time interval (TTI), or a group of time-frequency resource blocks. Accordingly, the operation/effect of buffer management and/or buffer management control according to exemplifying embodiments of the present invention can be performed/achieved on a respective level/unit basis.

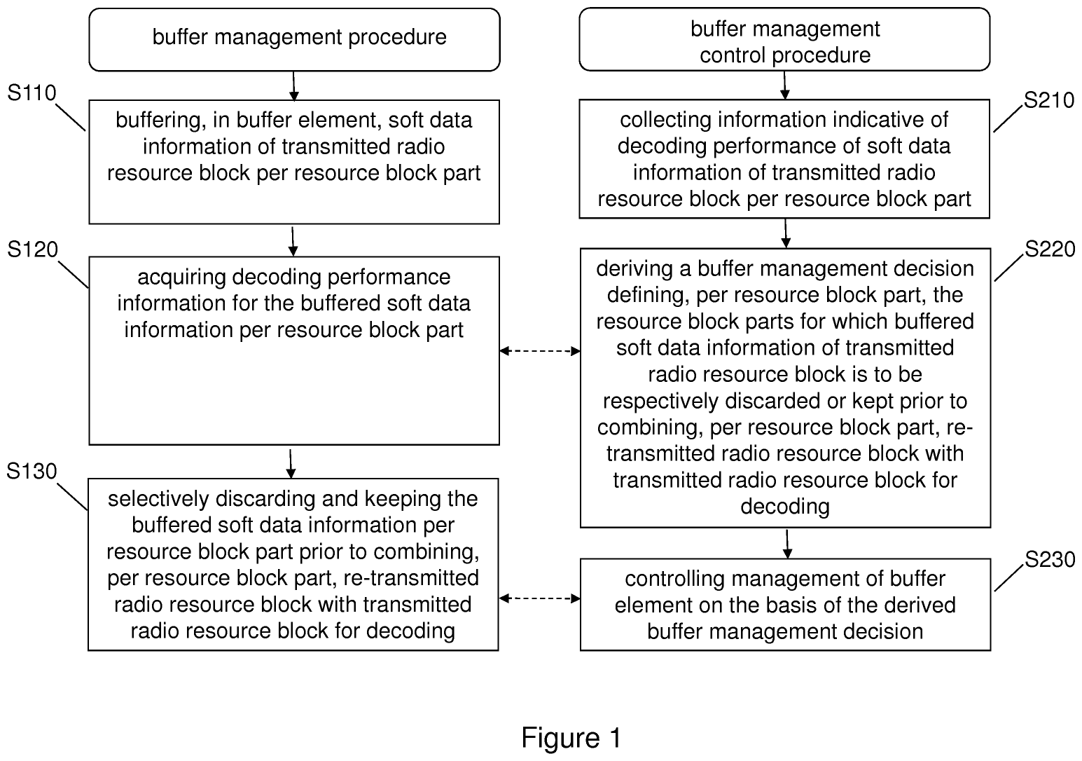

FIG. 1 shows a flowchart illustrating examples of procedures for buffer management and buffer management control according to exemplifying embodiments of the present invention. The procedures shown FIG. 1 are generically independent from each other, and can be executed at the same communication/network entity or at different communication/network entities. It is noted that any one of the thus illustrated procedures refers to a single/individual HARQ process, relating to re-/transmission of a single/individual radio resource block composed of plural resource block parts.

A procedure for buffer management according to exemplifying embodiments of the present invention is generally operable at a communication/network entity receiving re-/transmission of a radio resource block and having a retransmission buffer (buffer element). Such communication/network entity may be a communication terminal entity such as a UE in a DL use case, and may be a communication control entity such as a BS or eNB in an UL use case.

As shown in FIG. 1, a procedure for buffer management according to exemplifying embodiments of the present invention comprises
an operation (S110) of buffering, in a buffer element, soft data information of a transmitted radio resource block composed of a plurality of resource block parts per resource block part if retransmission of the transmitted radio resource block is requested for decoding the radio resource block,
an operation (S120) of acquiring decoding performance information for the buffered soft data information of the transmitted radio resource block per resource block part, and
an operation (S130) of selectively discarding and keeping, in the buffer element, the buffered soft data information of the transmitted radio resource block per resource block part based on the acquired decoding performance information prior to combining, per resource block part, soft data information of the re-transmitted radio resource block with buffered soft data information of the transmitted radio resource block for decoding the radio resource block.

Although not shown, the procedure for buffer management according to exemplifying embodiments of the present invention may further comprise
an operation of combining, per resource block part, the soft data information of the re-transmitted radio resource block with the soft data information of the transmitted radio resource block, which is selectively kept in the buffer element, and
an operation of decoding the radio resource block on the basis of the combined soft data information.

A procedure for buffer management control according to exemplifying embodiments of the present invention is generally operable at a communication/network entity controlling re-/transmission of a radio resource block and/or controlling buffer management. Such communication/network entity may be a communication control entity such as a BS or eNB or a communication terminal entity such as a UE in a DL use case, and may be a communication control entity such as a BS or UE in an UL use case.

As shown in FIG. 1, a procedure for buffer management control according to exemplifying embodiments of the present invention comprises
an operation (S210) of collecting information indicative of decoding performance of soft data information of a transmitted radio resource block composed of a plurality of resource block parts per resource block part, which is buffered in a buffer element, if retransmission of the transmitted radio resource block is requested for decoding the radio resource block,
an operation (S220) of deriving a buffer management decision on the basis of the collected information, said buffer management decision defining, per resource block part, the resource block parts for which the buffered soft data information of the transmitted radio resource block is to be respectively discarded or kept in the buffer element prior to combining, per resource block part, soft data information of the re-transmitted radio resource block with buffered soft data information of the transmitted radio resource block for decoding the radio resource block, and
an operation (S230) of controlling management of the buffer element on the basis of the derived buffer management decision.

As indicated in FIG. 1, despite the generic independence of the procedures for buffer management and buffer management control, the operation of acquiring decoding performance information (S120) in the procedure for buffer management and the operation of deriving a buffer management decision (S220) in the procedure for buffer management control, and the operation of selectively discarding and keeping buffered soft data information in the buffer element (S130) in the procedure for buffer management and the operation of controlling management of the buffer element (S230) in the procedure for buffer management control may be regarded as inherently/logically linked or correlated with each other, respectively.

Generally, it is noted that the decoding performance information (in the procedure for buffer management) as well as the information indicative of decoding performance (in the procedure for buffer management control) is indicative of a level of interference imposed on the respective soft data information of the transmitted radio resource block in each resource block part.

According to exemplifying embodiments of the present invention, the buffer management can be controlled or the buffer management decision can be made/derived on the basis of various information from various sources, which are available at the entity performing the buffer management procedure. Such information comprises one or more of following:
dynamic and/or semi-static interference pattern information regarding an influence of communications of neighboring cell/s (i.e. neighboring BS/s and UE/s) on the respective soft bits of the transmitted TB (in the example, information on interfered PRB's), which can be received (obtained) from the NW,
scheduling pattern information regarding puncturing (or preemptive scheduling) of respective soft bits of the transmitted TB, which can be locally detected/identified (obtained) from a scheduler at the BS, and
interference and/or decoding state information regarding the respective soft bits of the transmitted TB (in the example, HARQ feedback), which can be received (obtained) from the UE.

As to the aforementioned dynamic and/or semi-static interference pattern information, the following is noted.
It is desired or even expected (e.g. in the emerging 5G technology, including 5G New Radio) to allow transmission over very wide bandwidths with different TTI sizes (e.g. TTI sizes of single or multiple slots of 14 or 7 symbols and mini-slots of 2 symbols). Such transmissions are likely to be subject to potential non-uniform interference patterns at the receiver. For instance, a cell-edge eMBB UE served in DL over a 14-symbol slot may be interfered severely over the first 2 symbols (mini-slot) caused by DL URLLC traffic to UE/s in the neighboring cell/s. Thus, the plurality of CB's in an eMBB TB may experience different levels of interference. The BS/eNB can become aware of the interference pattern of the neighboring cell/s through interference coordination signaling e.g. the over Xn interface after the initial transmission to the eMBB UE. Such interference pattern can favorably by used as/in decoding performance information and/or information indicative of decoding performance according to exemplifying embodiments of the present invention.

As to the aforementioned interference and/or decoding state information, the following is noted.
It is desired or even expected (e.g. in the emerging 5G technology, including 5G New Radio) that high-resolution retransmission feedback is provided, i.e. multi-bit HARQ feedback. This includes options of non-/acknowledging
   each CB separately over the feedback channel as well as reporting decoder state information (DSI) which may indicate how close the decoder is to a successful decoding. The DSI metric can report for instance different non-acknowledgment (NACK) states about a CB or TB, such as the following:
Close to decoding—1 dB extra redundancy needed for decoding
Far from decoding—3 dB extra redundancy needed for decoding
Very far from decoding—for instance UE detects that the accumulated SINR is dramatically low (severe interference)

Multi-bit DSI-enriched HARQ feedback may indicate the level of accumulated SINR or mutual information for a decodable segment of the packet (e.g., per-CB or per-CBG feedback). Such interference and/or decoding state can favorably by used as/in decoding performance information and/or information indicative of decoding performance according to exemplifying embodiments of the present invention.

As to the aforementioned scheduling pattern information, the following is noted.
It is noted that partial retransmission of a large TB is the favorable option in case of punctured scheduling (e.g. pre-emption of eMBB resources for URLLC scheduling). For instance, various options of HARQ retransmission or automatic retransmission of only the punctured segments of a partly punctured packet can be adopted in this regard. It is also noted that control signaling accompanying the retransmission can be used to notify the receiver of coordination and size of the puncturing incident in the initial transmission attempt. Because of puncturing the affected CB's are likely to be punctured at different puncturing ratios causing different levels of interference experienced by each of the CBG's subject to retransmission. Thus, the contents of the HARQ buffer from the initial transmission could be either useful or hurtful to the HARQ combining for each of the affected CB/CBG's. Such scheduling pattern can favorably by used as/in decoding performance information and/or information indicative of decoding performance according to exemplifying embodiments of the present invention.

In the following, the effect of severe interference (in the form of a dynamic and/or semi-static interference or a transmission interruption, also known as puncturing or preemptive scheduling, e.g. due to sudden low-latency critical data for other UEs, also known as URLLC traffic), which constitutes the basis of the problem of potential error propagation through the HARQ process, is explained.

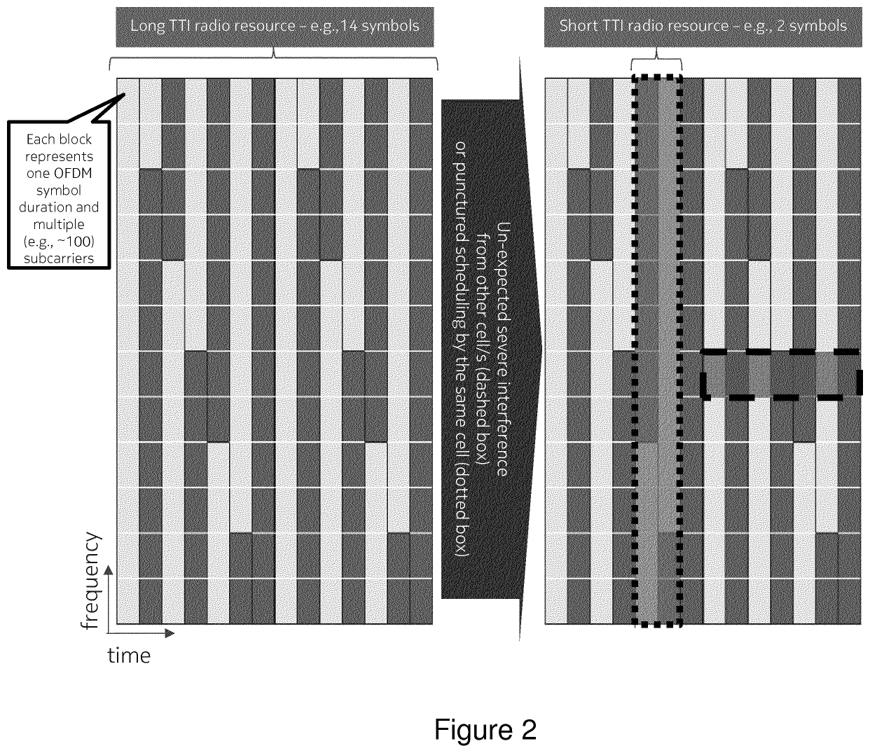

FIG. 2 shows a schematic diagram illustrating a radio resource block and an effect of localized interference on respective resource block parts of the radio resource block according to exemplifying embodiments of the present invention.

The illustration in FIG. 2 presents an example of a case where a large-size TB comprises 12 CB's, and where some CB's in the large-size TB get interfered at different levels. In FIG. 2, the individual CB's are visualized by alternating sequences of light and dark grey rectangles (OFDM symbols). That is, a sequence of 14 consecutive light or dark grey rectangles (OFDM symbols) represents a CB, respectively.

On the left side, the physical layer layout of the TB being composed of 12 CB's (at the sender), as is planned/used for transmission, e.g. DL transmission from a BS to an eMBB UE, is illustrated. On the right side, the physical layer layout of the TB being composed of 12 CB's (at the receiver), as has undergone transmission (at the receiver), e.g. DL transmission from a BS to an eMBB UE, is illustrated, together with the thus imposed interference.

Specifically, it is assumed that (the OFDM symbols of) CB's 4 to 6 are affected by severe interference resulting from punctured scheduling by the same cell (in which the TB is transmitted e.g. in DL), as is visualized by a dotted box, and that that (the OFDM symbols of) CB's 7 to 10 are affected by severe interference resulting from communications in neighboring cell/s (other than that in which the TB is transmitted e.g. in DL) such as URLLC traffic targeted at a different eMBB UE, as is visualized by a dashed box. In this regard, it is assumed that (the OFDM symbols of) CB's 7 to 10 are affected less than CB's 4 to 6, i.e. the level of interference imposed on the soft data information in CB's 7 to 10 is lower than the level of interference imposed on the soft data information in CB's 4 to 6.

Based on the thus resulting an uneven interference effect over the plurality of CB's in the large-size TB, it may be assumed/determined that, for example, retransmission of (the OFDM symbols of) CB's 4, 5, 6 and 10 is requested. Then, a corresponding multi-bit HARQ feedback calling for retransmitting CB's 4, 5, 6 and 10 may be provided, as exemplified below.

Based on the thus resulting an uneven interference effect over the plurality of CB's in the large-size TB, it may be assumed/determined that, for example, the buffered soft data information of CB 4 and CB 5 is severely interfered, thus being hurtful for the decoding process, and must be flushed from the HARQ buffer prior to HARQ combining with the retransmission (e.g. the retransmitted CB's 4, 5, 6 and 10), while the buffered soft data information of CB 6 and CB 10 is less interfered, thus being useful for the decoding process, and can be kept in the HARQ buffer for HARQ combining with the retransmission (e.g. the retransmitted CB's 4, 5, 6 and 10).

In view thereof, it is evident that exemplifying embodiments of the present invention offer flexibility in HARQ buffer management and HARQ buffer management control that can be implemented for example by means of control information. In practice, the collated information at the BS/eNB from one or more of various sources, such as interference pattern from the network, multi-bit HARQ feedback, and punctured scheduling pattern from the scheduler, can be used to make the buffer management decision which then will be signaled to the UE (in case of DL HARQ) or applied to the BS/eNB buffer (in case of UL HARQ).

For the subsequent description of exemplary use case, the exemplary configurations and assumptions, as described above in connection with FIG. 2, are adopted as a basis.

In the following, an exemplary DL use case, i.e. a case of DL HARQ, is exemplified.

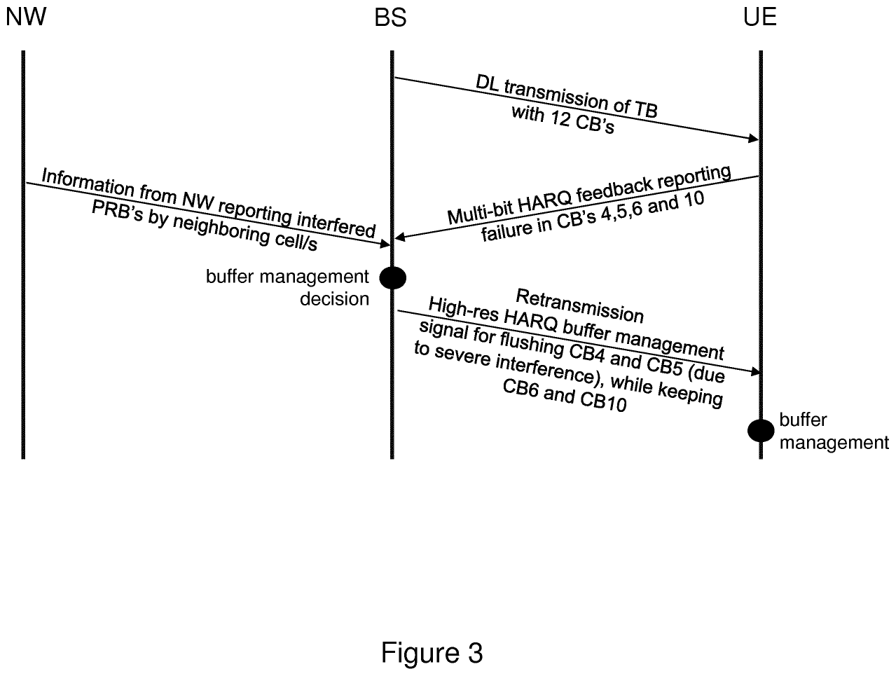

FIG. 3 shows a flow diagram illustrating an example of a procedural sequence in an exemplary DL use case according to exemplifying embodiments of the present invention. In FIG. 3, NW represents a communication network entity, BS represents a communication control entity, and UE represents a communication terminal entity. It is noted that the thus illustrated sequence refers to a single/individual HARQ process, while any one of the involved entities can concurrently handle multiple HARQ processes.

As shown in FIG. 3, the TB with 12 CB's, as illustrated on the left side of FIG. 2, is transmitted form the BS to the UE, and is received at the UE with the interference situation, as illustrated on the right side of FIG. 2. Based thereon, the UE determines that decoding of the TB fails, and retransmission thereof is requested for decoding the same. Hence, the UE buffers, in its HARQ buffer, the soft bits of CB's 1 to 12 (cf. operation 110 of FIG. 1). For acquiring decoding performance information, the UE provides multi-bit HARQ feedback (retransmission feedback) to the BS. In the multi-bit HARQ feedback, the UE indicates a retransmission request for CB's 4, 5, 6 and 10, together with interference and/or decoding state information regarding the soft bits of CB's 4, 5, 6 and 10.

The BS collects information indicative of decoding performance of the soft bits of CB's 1 to 12 (cf. operation 210 of FIG. 1), as mentioned above. Based on the thus collected information of decoding performance of the soft bits of CB's 1 to 12, the BS then derives a buffer management decision (cf. operation S220 of FIG. 1), and controls buffer management at the UE accordingly (cf. operation S230 of FIG. 1).

Here, the buffer management decision for keeping or flushing soft bits per CB in the HARQ buffer on the receive side can be made/derived based on the puncturing ratio (e.g., for CB's 4, 5 and 6 in the above example), interfered ratio (e.g., for CB 10 in the example above) and/or, if available, soft-feedback information, e.g. DSI-rich feedback using a given threshold on the accumulated mutual information for the given CB. Such pieces of information represent examples of the aforementioned scheduling pattern information, dynamic and/or semi-static interference pattern information and interference and/or decoding state information, respectively.

For controlling buffer management at the UE, the BS provides buffer management signaling (BMS) indicating the buffer management decision to the UE. The buffer management decision basically defines the CB's for which the buffered soft bits of the transmitted TB are to be respectively discarded or kept in the HARQ buffer of the UE. In the present example, the buffer management decision is that the soft bits of CB's 4 and 5 are to be discarded for the decoding process (because these are determined as hurtful due to more severe interference) and the soft bits of CB's 6 and 10 are to be used for the decoding process (because these are determined as useful due to less severe interference).

Thereby, the UE acquires decoding performance information for the buffered CB's 1 to 12 of the initially transmitted TB (cf. operation S120 of FIG. 1). The UE then performs buffer management accordingly, namely by flushing the soft bits of CB's 4 and 5 and keeping the soft bits of CB's 6 and 10 (cf. operation S130 of FIG. 2).

Basically at the same time with the buffer management signaling, the BS also retransmits the (relevant portion) of the TB. In the present example, the BS retransmits CB's 4, 5, 6 and 10 according to the retransmission process from the UE. The UE can thus perform an appropriate combining/decoding process on the basis of the remaining HARQ buffer contents (i.e. the soft bits of CB's 6 and 10) of the initially transmitted TB and the retransmitted TB (i.e. the soft bits of retransmitted CB's 4, 5, 6 and 10). In this regard, it is noted that the parts of the buffer, i.e. the soft bits of the initially transmitted TB, that are not flushed, are erroneous, but not severely interfered, and thus still useful for combining/decoding.

According to exemplifying embodiments of the present invention, the buffer management signaling (BMS) can be regarded as a high-resolution BMS, as it contains control information for various resource block parts such as CB's and thus enables buffer management control per resource block part such as CB. The high-resolution buffer management signal (BMS), as illustrated in the example of FIG. 3, can for instance replace the single-bit NDI.

In the example of FIG. 3, the retransmission conveys only the failed CB's in the initial attempt or attempts (i.e. CB's 4, 5, 6 and 10 in the example). Therefore, DCI from the BS to the UE conveys a signal indicating the retransmitted CB's to the UE. For instance, a vector signal such as {0,0,0,1,1,1,0,0,0,1,0,0} can indicate to the UE as to which CB's from the initial TB are included in the retransmission (0 indicating no retransmission for the corresponding CB, while 1 indicates that the corresponding CB is included in the retransmission). The high-resolution buffer management signal (BMS) could then follow a similar approach and, for instance, provide a vector such as {0,0,0,0,0,1,0,0,0,1,0,0}, where the 12 bits correspond respectively to all of the initially transmitted CB's 1 to 12 of the TB (0 indicating flushing the HARQ buffer for the corresponding CB before combining, while 1 indicates utilizing the HARQ buffer contents for the corresponding CB). Such vector could also have reduced overhead by only indicating control information for buffer management for the retransmitted CB's. For instance, for the example of FIG. 3, a vector such as {0,0,1,1} will indicate similar HARQ buffer management signaling to the UE, where the 4 bits correspond respectively to the retransmitted CB's 4, 5, 6 and 10 only.

As shown in the above example, according to exemplifying embodiments of the present invention, high-resolution HARQ buffer management signaling (BMS) for triggering/controlling buffer management at the transmitter can for instance be generated by the BS/eNB and sent as part of DCI of a retransmission grant in a DL HARQ operation.

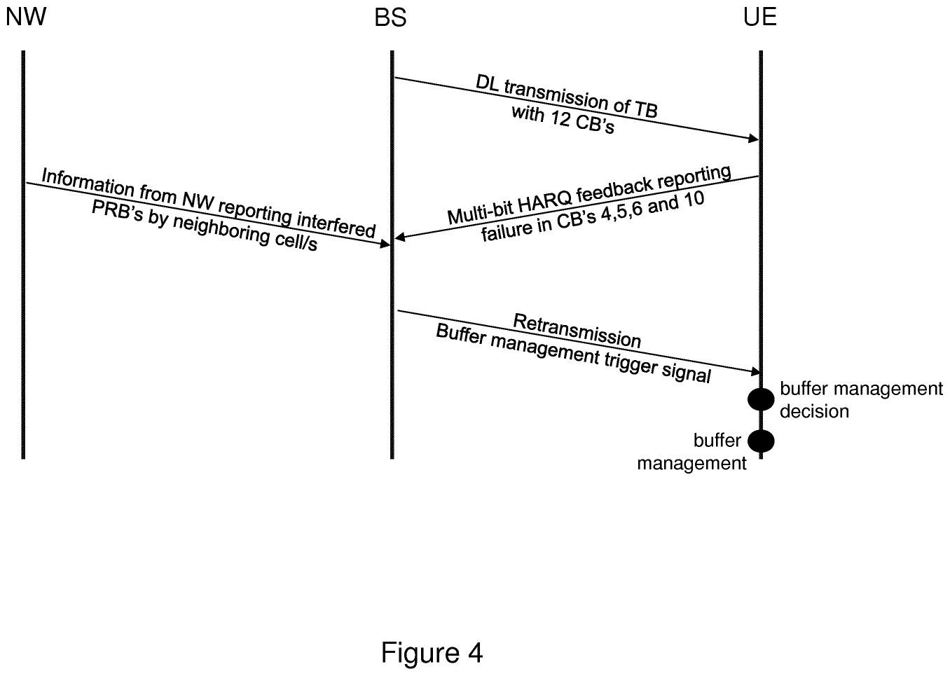

FIG. 4 shows a flow diagram illustrating another example of a procedural sequence in an exemplary DL use case according to exemplifying embodiments of the present invention. In FIG. 4, NW represents a communication network entity, BS represents a communication control entity, and UE represents a communication terminal entity. It is noted that the thus illustrated sequence refers to a single/individual HARQ process, while any one of the involved entities can concurrently handle multiple HARQ processes.

As shown in FIG. 4, the first part of the sequence is the same as that of FIG. 3, and reference is made to the above description accordingly.

The sequence of FIG. 4 differs from that of FIG. 3 basically in that the buffer management decision is not made or derived at/by the BS but at/by the UE itself. To this end, the BS can provide a buffer management trigger signal to the UE, possibly depending on available information as indicated above. Based on such trigger, the UE can make or derive the buffer management decision, i.e. calculate buffer management information indicating such buffer management decision. For example, the UE can be able to make or derive the buffer management decision for its own use in case of having e.g. DSI or SINR or other decoding state metrics collected (i.e. interference and/or decoding state information).

Thereby, the UE acquires decoding performance information for the buffered CB's of the initially transmitted TB, and the UE then performs buffer management accordingly, e.g. by flushing the soft bits of CB's 4 and 5 and keeping the soft bits of CB's 6 and 10.

As illustrated, such autonomous buffer management control action at the UE can be triggered for instance by control signaling from the BS. Such trigger can be regarded as authorization for conducting such autonomous buffer management control action at the UE, or can interact/cooperate with some other authorization in this regard. Alternatively, it can be triggered by other means, e.g. by the UE itself, such as upon reception of the requested retransmission.

In the following, an exemplary UL use case, i.e. a case of UL HARQ, is exemplified.

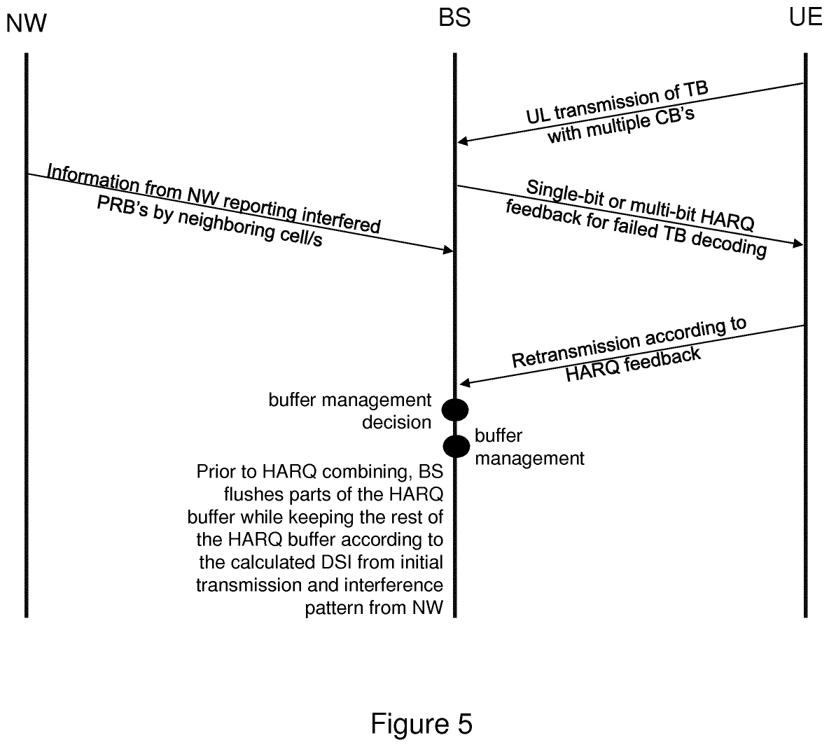

FIG. 5 shows a flow diagram illustrating an example of a procedural sequence in an exemplary UL use case according to exemplifying embodiments of the present invention. In FIG. 5, NW represents a communication network entity, BS represents a communication control entity, and UE represents a communication terminal entity. It is noted that the thus illustrated sequence refers to a single/individual HARQ process, while any one of the involved entities can concurrently handle multiple HARQ processes.

As shown in FIG. 3 or 4, a TB with multiple CB's, e.g. as illustrated on the left side of FIG. 2, is transmitted form the UE to the BS, and is received at the BS with an interference situation, e.g. as illustrated on the right side of FIG. 2. Based thereon, the BS determines that decoding of the TB fails, and retransmission thereof is requested for decoding the same. Hence, the BS buffers, in its HARQ buffer, the relevant soft bits of interference-affected CB's (cf. operation 110 of FIG. 1). Then, the BS provides single-bit or multi-bit HARQ feedback (retransmission feedback) to the UE, e.g. over the PHICH. In the HARQ feedback, the UE indicates a retransmission request for the interference-affected CB's. Based thereon, the thus requested CB's are retransmitted from the UE to the BS.

In the meantime, the BS collects information indicative of decoding performance of the soft bits of the interference-affected CB's (cf. operation 210 of FIG. 1), as mentioned above. Based on the thus collected information of decoding performance, the BS then derives a buffer management decision (cf. operation S220 of FIG. 1), and controls buffer management at the BS accordingly (cf. operation S230 of FIG. 1).

Here, the buffer management decision for keeping or flushing soft bits per CB in the HARQ buffer on the receive side can be made/derived based on the same pieces of information, as described above for the DL use case. The only difference is that the scheduling pattern information is not locally available at the BS but is to be obtained/received from a scheduler of/at the UE, and the interference and/or decoding state information is not to be obtained/received from the UE but is locally available.

For controlling buffer management at the BS, the BS calculates buffer management information indicating a buffer management decision. As described above for the DL use case, the buffer management decision basically defines the CB's for which the buffered soft bits of the transmitted TB are to be respectively discarded or kept in the HARQ buffer of the BS.

Thereby, the BS acquires decoding performance information for the buffered CB's of the initially transmitted TB (cf. operation S120 of FIG. 1). The BS then performs buffer management accordingly, e.g. by flushing the soft bits of CB's 4 and 5 and keeping the soft bits of CB's 6 and 10 (cf. operation S130 of FIG. 2).

For further details of the procedural sequence in the UL use case of FIG. 5, reference is made to the description of the procedural sequence in the DL use case of FIG. 3 or 4 above. Namely, besides the above-outlines differences, the basics and specifics of the DL and UL HARQ cases are essentially the same or at least equivalent, and a more detailed explanation of the UL use case is thus deemed to be dispensable in view of the above explanation of the DL use case and omitted accordingly.

In the above methods, procedures and functions, various determinations and/or evaluations are made or adopted as a basis. Such determinations and/or evaluations include, for instance, determination/evaluation as to whether a retransmission of an initially transmitted radio resource block is required or requested (or, stated in other words, whether an initial transmission and/or decoding of an initially transmitted radio resource block failed), determination/evaluation of a level of interference imposed on respective soft data information of an initially transmitted radio resource block, determination/evaluation as to which resource block parts of an initially transmitted radio resource block are to be retransmitted, or the like.

It is noted that all of these are assumed to be readily realizable by a skilled person, without requiring any further information (which is thus not given for the sake of lucidity and simplicity). Irrespective thereof, the following brief description is given for illustrative purposes in this regard.
Determination of a failed packet decoding for a code block can be accomplished by means of error detecting codes. For example, cyclic redundancy check (CRC) codes can be embedded in a code block prior to error-correcting channel coding such as using a Turbo code. Such CRC bits can be used by the decoder to determine whether the error-correcting code has been able to correct all the errors caused in the transmission by noise and/or interference.
In order to evaluate the level of interference imposed on a code block, the receiver node can estimate for example the received SINR over the physical resources used for transmitting the code block. Other methods such as calculating DSI in the form of normalized accumulated mutual information (NACMI) from soft decoding bits, or monitoring the number of toggled soft bits between each two decoding iterations can be used to evaluate interference level. For example, a threshold on the number of toggled bits from iteration 7 to iteration 8 of the Turbo decoding process can be used to indicate whether the code block is severely interfered or not.

As shown in the above example, according to exemplifying embodiments of the present invention, high-resolution HARQ buffer management for triggering/controlling buffer management at the transmitter can for instance be conducted by the BS/eNB and applied locally in an UL HARQ operation.

By virtue of exemplifying embodiments of the present invention, as evident from the above, flexible retransmission-process buffer management, such as e.g. flexible HARQ process buffer management, can be enabled/realized in the context of re-/transmission of a radio resource block composed of a plurality of resource block parts. That is, in a scenario of re-/transmission of a radio resource block composed of a plurality of resource block parts, it is beneficially possible to increase the flexibility of the retransmission process so that buffered soft data information buffer per resource block part will be used in the combining/decoding process only if the buffer content is determined as ‘useful’ to the decoding performance and will be discarded for the combining/decoding process if the buffer content is determined as ‘hurtful’ to the decoding performance.

In brief summary, according to exemplifying embodiments of the present invention, the problem of retransmission (e.g. HARQ) error propagation through a retransmission (e.g. HARQ) process, potentially occurring in a retransmission technique (e.g. HARQ) with soft combining, can thus be addressed. Namely, it can be avoided that an error, as an effect of sever interference, propagates through a retransmission (e.g. HARQ) process in that its adverse influence on a combining/decoding process after (e.g. HARQ) retransmission can be avoided. Accordingly, performance benefits can be attained in that reduced performance for packets, which consequently will result in reduced throughput as well as packet delivery latency, can be prevented or at least mitigated. This can be achieved by way of flexible buffer management and/or buffer management control such that initially buffered soft data information of a radio resource block or packet can be partly used and partly discarded, i.e. the buffer contents of soft data information can be partly kept and partly flushed/deleted, prior to be combined with retransmitted soft data information of (at least a relevant portion of) the same radio resource block or packet.

Exemplifying embodiments of the present invention encompass any one of a buffer management technique and a buffer management control technique.
In the buffer management technique, flexible buffer management is conducted at the receiver, which could be triggered by buffer management signaling or decided autonomously, based on e.g. interference pattern, puncturing pattern, decoding process performance, etc. The receiver selectively discard parts of the HARQ buffer upon receiving a retransmission version of the packet and performs combining of the retransmission version with only the remaining parts of the HARQ buffer
In the buffer management control technique, collection of information about the interference that has struck a packet transmission is conducted, followed by making a buffer management decision based thereon.

As an example, without restricting general applicability of exemplifying embodiments of the present invention, the present disclosure focuses on cases where the HARQ transmission of a TB is constructed on multiple CBs. Decoding errors at the receiver may be caused by time-variant severe localized interference harming a subset of the CB's of the HARQ TB transmission. Decoding errors at the receiver may also be caused in the case where the transmitter on purpose inflicts errors on the HARQ TB transmission by e.g. puncturing part of the transmission. Accordingly, both of these types of potential interference are considered by way of example. The present disclosure teaches, in principle, a smarter HARQ process buffer handling, including partial HARQ process buffer flushing to avoid undesirable error propagation. In this regard, various information can be used (e.g. interference coordination, multi-bit feedback, and puncturing decisions at the scheduler) to create an efficient retransmission for the faulty segments of the TB. The HARQ buffer corresponding to the severely interfered CB's must therefore be flushed prior to combining to avoid propagation of the interference effect. Hence, the present disclosure proposes techniques of high resolution (as opposed to rigid single-bit NDI) control signaling and techniques of flexible HARQ buffer management in a large transport block size scenario.

The above-described methods, procedures and functions may be implemented by respective functional elements, entities, modules, units, processors, or the like, as described below.

While in the foregoing exemplifying embodiments of the present invention are described mainly with reference to methods, procedures and functions, corresponding exemplifying embodiments of the present invention also cover respective apparatuses, entities, modules, units, network nodes and/or systems, including both software and/or hardware thereof.

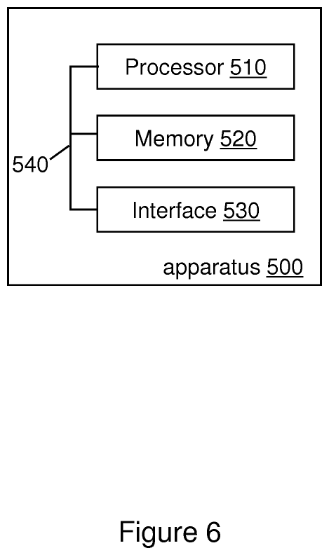

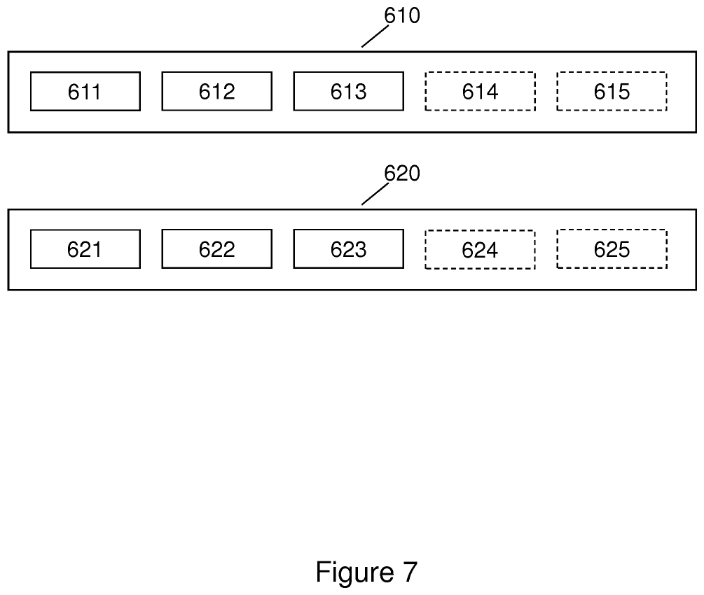

Respective exemplifying embodiments of the present invention are described below referring to FIGS. 6 and 7, while for the sake of brevity reference is made to the detailed description of respective corresponding configurations/setups, schemes, methods and functionality, principles and operations according to FIGS. 1 to 5.

In FIGS. 6 and 7, the blocks are basically configured to perform respective methods, procedures and/or functions as described above. The entirety of blocks are basically configured to perform the methods, procedures and/or functions as described above, respectively. With respect to FIGS. 6 and 7, it is to be noted that the individual blocks are meant to illustrate respective functional blocks implementing a respective function, process or procedure, respectively. Such functional blocks are implementation-independent, i.e. may be implemented by means of any kind of hardware or software or combination thereof, respectively.

Further, in FIGS. 6 and 7, only those functional blocks are illustrated, which relate to any one of the above-described methods, procedures and/or functions. A skilled person will acknowledge the presence of any other conventional functional blocks required for an operation of respective structural arrangements, such as e.g. a power supply, a central processing unit, respective memories or the like. Among others, one or more memories are provided for storing programs or program instructions for controlling or enabling the individual functional entities or any combination thereof to operate as described herein in relation to exemplifying embodiments. Also, one or more memories can represent a buffer element and/or provide a functionality of a buffer element, such as a HARQ (process) buffer.

FIG. 6 shows a schematic diagram illustrating an example of a structure of apparatuses according to exemplifying embodiments of the present invention.

As indicated in FIG. 6, according to exemplifying embodiments of the present invention, an apparatus 500 may comprise at least one processor 510 and at least one memory 520 (and possibly also at least one interface 530), which may be operationally connected or coupled, for example by a bus 540 or the like, respectively.

The processor 510 and/or the interface 530 of the apparatus 500 may also include a modem or the like to facilitate communication over a (hardwire or wireless) link, respectively. The interface 530 of the apparatus 500 may include a suitable transmitter, receiver or transceiver connected or coupled to one or more antennas, antenna units, such as antenna arrays or communication facilities or means for (hardwire or wireless) communications with the linked, coupled or connected device(s), respectively. The interface 530 of the apparatus 500 is generally configured to communicate with at least one other apparatus, device, node or entity (in particular, the interface thereof).

The memory 520 of the apparatus 500 may represent a (non-transitory/tangible) storage medium and store respective software, programs, program products, macros or applets, etc. or parts of them, which may be assumed to comprise program instructions or computer program code that, when executed by the respective processor, enables the respective electronic device or apparatus to operate in accordance with the exemplifying embodiments of the present invention. Further, the memory 520 of the apparatus 500 may (comprise a database to) store any data, information, or the like, which is used in the operation of the apparatus.

In general terms, respective apparatuses (and/or parts thereof) may represent means for performing respective operations and/or exhibiting respective functionalities, and/or the respective devices (and/or parts thereof) may have functions for performing respective operations and/or exhibiting respective functionalities.

In view of the above, the thus illustrated apparatus 500 is suitable for use in practicing one or more of the exemplifying embodiments of the present invention, as described herein.

When in the subsequent description it is stated that the processor (or some other means) is configured to perform some function, this is to be construed to be equivalent to a description stating that a (i.e. at least one) processor or corresponding circuitry, potentially in cooperation with a computer program code stored in the memory of the respective apparatus or otherwise available (it should be appreciated that the memory may also be an external memory or provided/realized by a cloud service or the like), is configured to cause the apparatus to perform at least the thus mentioned function.

According to exemplifying embodiments of the present invention, the thus illustrated apparatus 500 may represent or realize/embody a (part of a) entity of a communication system.

Specifically, the thus illustrated apparatus 500 may be configured to perform a procedure and/or exhibit a functionality and/or implement a mechanism for buffer management, as illustrated on the left side of FIG. 1, and described for the UE of FIG. 3 or 4 and/or the BS of FIG. 5.

Accordingly, the apparatus 500 may be caused or the apparatus 500 or its at least one processor 510 (possibly together with computer program code stored in its at least one memory 520), in a basic form, is configured to buffer, in a buffer element, soft data information of a transmitted radio resource block composed of a plurality of resource block parts per resource block part if retransmission of the transmitted radio resource block is requested for decoding the radio resource block, acquire decoding performance information for the buffered soft data information of the transmitted radio resource block per resource block part, and selectively discard and keep, in the buffer element, the buffered soft data information of the transmitted radio resource block per resource block part based on the acquired decoding performance information prior to combining, per resource block part, soft data information of the re-transmitted radio resource block with buffered soft data information of the transmitted radio resource block for decoding the radio resource block.

Specifically, the thus illustrated apparatus 500 may be configured to perform a procedure and/or exhibit a functionality and/or implement a mechanism for buffer management control, as illustrated on the right side of FIG. 1, and described for the BS of FIG. 3 and/or FIG. 5 or the UE of FIG. 4.

Also, the apparatus 500 may be caused or the apparatus 500 or its at least one processor 510 (possibly together with computer program code stored in its at least one memory 520), in a basic form, is configured to collect information indicative of decoding performance of soft data information of a transmitted radio resource block composed of a plurality of resource block parts per resource block part, which is buffered in a buffer element, if retransmission of the transmitted radio resource block is requested for decoding the radio resource block, derive a buffer management decision on the basis of the collected information, said buffer management decision defining, per resource block part, the resource block parts for which the buffered soft data information of the transmitted radio resource block is to be respectively discarded or kept in the buffer element prior to combining, per resource block part, soft data information of the re-transmitted radio resource block with buffered soft data information of the transmitted radio resource block for decoding the radio resource block, and control management of the buffer element on the basis of the derived buffer management decision.

As mentioned above, any apparatus according to exemplifying embodiments of the present invention may be structured by comprising respective units or means for performing corresponding operations, procedures and/or functions. For example, such units or means may be implemented/realized on the basis of an apparatus structure, as exemplified in FIG. 6, i.e. by one or more processors 510, one or more memories 520, one or more interfaces 530, or any combination thereof.

FIG. 6 shows a schematic diagram illustrating another example of a functional structure of apparatuses according to exemplifying embodiments of the present invention. Generally, it is noted that any such apparatus may be realized in a physical form, i.e. as or in any specified network node or entity, or in logical form, i.e. as or in any specified network function.

It is to be noted that the individual apparatuses shown in FIG. 7 are inherently independent from each other but could be realized/implemented in, by or at a single entity of a communication system. It is noted exemplifying embodiments of the present invention cover any one of these apparatuses alone or any combination of such apparatuses (including one or more of any one of these apparatuses).

As shown in FIG. 7, an apparatus 610 according to exemplifying embodiments of the present invention may comprise (at least) a unit or means 611 for buffering, in a buffer element, soft data information of a transmitted radio resource block composed of a plurality of resource block parts per resource block part if retransmission of the transmitted radio resource block is requested for decoding the radio resource block, a unit or means 612 for acquiring decoding performance information for the buffered soft data information of the transmitted radio resource block per resource block part, and a unit or means 613 for selectively discarding and keeping, in the buffer element, the buffered soft data information of the transmitted radio resource block per resource block part based on the acquired decoding performance information prior to combining, per resource block part, soft data information of the re-transmitted radio resource block with buffered soft data information of the transmitted radio resource block for decoding the radio resource block.

As evident from the above, the apparatus 610 may optionally also comprise a unit or means 614 for combining, per resource block part, the soft data information of the re-transmitted radio resource block with the soft data information of the transmitted radio resource block, which is selectively kept in the buffer element, and decoding the radio resource block on the basis of the combined soft data information. Also, the apparatus 610 may optionally also comprise a unit or means 615 for providing retransmission feedback and/or receiving the retransmitted radio resource block comprising either all of the resource block parts of the radio resource block or only a subset of the resource block parts of the radio resource block according to a retransmission request.

As shown in FIG. 7, an apparatus 620 according to exemplifying embodiments of the present invention may comprise (at least) a unit or means 621 for collecting information indicative of decoding performance of soft data information of a transmitted radio resource block composed of a plurality of resource block parts per resource block part, which is buffered in a buffer element, if retransmission of the transmitted radio resource block is requested for decoding the radio resource block, a unit or means 622 for deriving a buffer management decision on the basis of the collected information, said buffer management decision defining, per resource block part, the resource block parts for which the buffered soft data information of the transmitted radio resource block is to be respectively discarded or kept in the buffer element prior to combining, per resource block part, soft data information of the re-transmitted radio resource block with buffered soft data information of the transmitted radio resource block for decoding the radio resource block, and a unit or means 623 for controlling management of the buffer element on the basis of the derived buffer management decision.

As evident from the above, the apparatus 620 may optionally also comprise a unit or means 624 for providing buffer management signaling indicating the buffer management decision, or calculating and applying buffer management information indicating the buffer management decision. Also, the apparatus 620 may optionally also comprise a unit or means 625 for obtaining any one or more of dynamic and/or semi-static interference pattern information, scheduling pattern information, and interference and/or decoding state information.

For further details regarding the operability/functionality of the individual apparatuses (or units/means thereof) according to exemplifying embodiments of the present invention, reference is made to the above description in connection with any one of FIGS. 1 to 5, respectively.

According to exemplifying embodiments of the present invention, any one of the (at least one) processor, the (at least one) memory and the (at least one) interface, as well as any one of the illustrated units/means, may be implemented as individual modules, chips, chipsets, circuitries or the like, or one or more of them can be implemented as a common module, chip, chipset, circuitry or the like, respectively.

According to exemplifying embodiments of the present invention, a system may comprise any conceivable combination of the thus depicted apparatuses and other network elements or functional entities, which are configured to cooperate as described above.

In general, it is to be noted that respective functional blocks or elements according to above-described aspects can be implemented by any known means, either in hardware and/or software, respectively, if it is only adapted to perform the described functions of the respective parts. The mentioned method steps can be realized in individual functional blocks or by individual devices, or one or more of the method steps can be realized in a single functional block or by a single device.

Generally, any method step is suitable to be implemented as software or by hardware without changing the idea of the present invention. Such software may be software code independent and can be specified using any known or future developed programming language, such as e.g. Java, C++, C, and Assembler, as long as the functionality defined by the method steps is preserved. Such hardware may be hardware type independent and can be implemented using any known or future developed hardware technology or any hybrids of these, such as MOS (Metal Oxide Semiconductor), CMOS (Complementary MOS), BiMOS (Bipolar MOS), BiCMOS (Bipolar CMOS), ECL (Emitter Coupled Logic), TTL (Transistor-Transistor Logic), etc., using for example ASIC (Application Specific IC (Integrated Circuit)) components, FPGA (Field-programmable Gate Arrays) components, CPLD (Complex Programmable Logic Device) components or DSP (Digital Signal Processor) components. A device/apparatus may be represented by a semiconductor chip, a chipset, or a (hardware) module comprising such chip or chipset; this, however, does not exclude the possibility that a functionality of a device/apparatus or module, instead of being hardware implemented, be implemented as software in a (software) module such as a computer program or a computer program product comprising executable software code portions for execution/being run on a processor. A device may be regarded as a device/apparatus or as an assembly of more than one device/apparatus, whether functionally in cooperation with each other or functionally independently of each other but in a same device housing, for example.

Apparatuses and/or units/means or parts thereof can be implemented as individual devices, but this does not exclude that they may be implemented in a distributed fashion throughout the system, as long as the functionality of the device is preserved. Such and similar principles are to be considered as known to a skilled person.

Software in the sense of the present description comprises software code as such comprising code means or portions or a computer program or a computer program product for performing the respective functions, as well as software (or a computer program or a computer program product) embodied on a tangible medium such as a computer-readable (storage) medium having stored thereon a respective data structure or code means/portions or embodied in a signal or in a chip, potentially during processing thereof.

The present invention also covers any conceivable combination of method steps and operations described above, and any conceivable combination of nodes, apparatuses, modules or elements described above, as long as the above-described concepts of methodology and structural arrangement are applicable.

In view of the above, there are provided measures for flexible retransmission-process buffer management, such as e.g. flexible HARQ process buffer management, in the context of re-/transmission of a radio resource block composed of a plurality of resource block parts. Such measures exemplarily comprise buffer management and buffer management control, wherein a buffer element is flexibly managed by selectively discarding and keeping buffered soft data information of a transmitted radio resource block per resource block part based on decoding performance information for the buffered soft data information of the transmitted radio resource block prior to combining, per resource block part, soft data information of a retransmitted radio resource block with buffered soft data information of the transmitted radio resource block for decoding the radio resource block.

Even though the invention is described above with reference to the examples according to the accompanying drawings, it is to be understood that the invention is not restricted thereto. Rather, it is apparent to those skilled in the art that the present invention can be modified in many ways without departing from the scope of the inventive idea as disclosed herein.

### LIST OF ACRONYMS AND ABBREVIATIONS

3GPP 3^{rd} Generation Partnership Program
5G 5^{th} Generation
ARQ Automatic Repeat reQuest
BMS Buffer Management Signaling
BS Base Station
CB Code Block
CBG Code Block Group
DCI Downlink Control Information
DL Downlink
DSI Decoder State Information
eMBB enhanced Mobile BroadBand
eNB evolved NodeB
HARQ Hybrid Automatic Repeat reQuest
LTE Long Term Evolution
NACMI Normalized ACcumulated Mutual Information
NDI New Data Indicator
NW Network (core)
OFDM Orthogonal Frequency-Division Multiplexing
PHICH Physical HARQ Indicator Channel
PRB Physical Resource Block
SINR Signal-to-Interference-and-Noise-Ratio
TB Transport Block
TTI Transmission Time Interval
UE User Equipment
UL Uplink
URLLC Ultra-Reliable Low-Latency Communication
Xn BS-to-BS interface for 5G New Radio

1. A method, comprising:
buffering, in a buffer element, soft data information of a transmitted radio resource block composed of a plurality of resource block parts per resource block part if retransmission of the transmitted radio resource block is requested for decoding the radio resource block,
acquiring decoding performance information for the buffered soft data information of the transmitted radio resource block per resource block part, and
selectively discarding and keeping, in the buffer element, the buffered soft data information of the transmitted radio resource block per resource block part based on the acquired decoding performance information prior to combining, per resource block part, soft data information of the retransmitted radio resource block with buffered soft data information of the transmitted radio resource block for decoding the radio resource block.

2. The method according to claim 1, further comprising:
combining, per resource block part, the soft data information of the retransmitted radio resource block with the soft data information of the transmitted radio resource block, which is selectively kept in the buffer element, and
decoding the radio resource block on the basis of the combined soft data information.

3. The method according to claim 1, wherein:
the decoding performance information is indicative of a level of interference imposed on the respective soft data information of the transmitted radio resource block in each resource block part.

4. The method according to claim 1, wherein:
the radio resource block represents downlink traffic transmitted and retransmitted from a communication control entity to a communication terminal entity.

5. The method according to claim 4, wherein:
the decoding performance information is acquired by provision of buffer management signaling indicating a buffer management decision by the communication control entity, said buffer management decision defining the resource block parts for which the buffered soft data information of the transmitted radio resource block is to be respectively discarded or kept in the buffer element at the communication terminal entity.

6. The method according to claim 5, wherein the buffer management decision is made on the basis of at least one of:
dynamic and/or semi-static interference pattern information regarding an influence of communications of neighboring communication control and/or terminal entities on the respective soft data information of the transmitted radio resource block,
scheduling pattern information regarding puncturing of respective resource block parts of the transmitted radio resource block, or
interference and/or decoding state information regarding the respective soft data information of the transmitted radio resource block.

7. The method according to claim 4, wherein:
the decoding performance information is acquired by calculation of buffer management information indicating a buffer management decision by the communication terminal entity, said buffer management decision defining the resource block parts for which the buffered soft data information of the transmitted radio resource block is to be respectively discarded or kept in the buffer element at the communication terminal entity.

8. The method according to claim 7, wherein the buffer management decision is made on the basis of:
interference and/or decoding state information regarding the respective soft data information of the transmitted radio resource block.

9. The method according to claim 4, further comprising:
providing retransmission feedback for the communication control entity, said retransmission feedback indicating, per resource block part, at least one of a retransmission request and interference and/or decoding state information regarding the respective soft data information of the transmitted radio resource block, and/or
receiving the retransmitted radio resource block from the communication control entity, said retransmitted radio resource block comprising either all of the resource block parts of the radio resource block or only a subset of the resource block parts of the radio resource block according to the retransmission request.

10. The method according to claim 1, wherein:
the radio resource block represents uplink traffic transmitted and re-transmitted from a communication terminal entity to a communication control entity.

11. The method according to claim 10, wherein:
the decoding performance information is acquired by calculation of buffer management information indicating a buffer management decision by the communication control entity, said buffer management decision defining the resource block parts for which the buffered soft data information of the transmitted radio resource block is to be respectively discarded or kept in the buffer element at the communication control entity.

12. The method according to claim 11, wherein the buffer management decision is made on the basis of at least one of:
dynamic and/or semi-static interference pattern information regarding an influence of communications of neighboring communication control and/or terminal entities on the respective soft data information of the transmitted radio resource block,
scheduling pattern information regarding puncturing of respective resource block parts of the transmitted radio resource block, or
interference and/or decoding state information regarding the respective soft data information of the transmitted radio resource block.

13. The method according to claim 10, further comprising:
providing retransmission feedback for the communication terminal entity, said retransmission feedback indicating, per resource block part, a retransmission request, and/or
receiving the retransmitted radio resource block from the communication terminal entity, said retransmitted radio resource block comprising either all of the resource block parts of the radio resource block or only a subset of the resource block parts of the radio resource block according to the retransmission request.

14. The method according to claim 1, wherein:
transmission and re-transmission of the radio resource block is controlled by a HARQ protocol, and/or
the radio resource block is a transport block, and/or
the resource block part is one of a code block, a group of code blocks, a time-frequency resource block such as a physical resource block or a transmission time interval, or a group of time-frequency resource blocks.

15. A method, comprising:
collecting information indicative of decoding performance of soft data information of a transmitted radio resource block composed of a plurality of resource block parts per resource block part, which is buffered in a buffer element, if retransmission of the transmitted radio resource block is requested for decoding the radio resource block,
deriving a buffer management decision on the basis of the collected information, said buffer management decision defining, per resource block part, the resource block parts for which the buffered soft data information of the transmitted radio resource block is to be respectively discarded or kept in the buffer element prior to combining, per resource block part, soft data information of the re-transmitted radio resource block with buffered soft data information of the transmitted radio resource block for decoding the radio resource block, and
controlling management of the buffer element on the basis of the derived buffer management decision.

16. The method according to claim 15, wherein:
the information indicative of decoding performance is indicative of a level of interference imposed on the respective soft data information of the transmitted radio resource block in each resource block part.

17. The method according to claim 15, wherein the information indicative of decoding performance comprises at least one of:
dynamic and/or semi-static interference pattern information regarding an influence of communications of neighboring communication control and/or terminal entities on the respective soft data information of the transmitted radio resource block,
scheduling pattern information regarding puncturing of respective resource block parts of the transmitted radio resource block, or
interference and/or decoding state information regarding the respective soft data information of the transmitted radio resource block.

18. The method according to claim 15, wherein:
the radio resource block represents downlink traffic transmitted and re-transmitted from a communication control entity to a communication terminal entity.

19. The method according to claim 18, wherein controlling management of the buffer element comprises:
providing buffer management signaling indicating the buffer management decision by the communication control entity to the communication terminal entity.

20. The method according to claim 19, further comprising at least one of:
obtaining the dynamic and/or semi-static interference pattern information from a communication network entity,
obtaining the scheduling pattern information from a scheduler element at the communication control entity, or
obtaining the interference and/or decoding state information in the form of retransmission feedback from the communication terminal entity.

21. The method according to claim 18, wherein controlling management of the buffer element comprises:
calculating and applying buffer management information indicating the buffer management decision at the communication terminal entity.

22. The method according to claim 21, further comprising:
obtaining the interference and/or decoding state information at the communication terminal entity.

23. The method according to claim 15, wherein:
the radio resource block represents uplink traffic transmitted and re-transmitted from a communication terminal entity to a communication control entity.

24. The method according to claim 23, wherein controlling management of the buffer element comprises:
calculating and applying buffer management information indicating the buffer management decision at the communication control entity.

25. The method according to claim 23, further comprising at least one of:
obtaining the dynamic and/or semi-static interference pattern information from a communication network entity,
obtaining the scheduling pattern information from a scheduler element at the communication terminal entity, or
obtaining the interference and/or decoding state information from a decoding element at the communication control entity.

26. The method according to claim 15, wherein:
transmission and re-transmission of the radio resource block is controlled by a HARQ protocol, and/or
the radio resource block is a transport block, and/or
the resource block part is one of a code block, a group of code blocks, a time-frequency resource block such as a physical resource block or a transmission time interval, or a group of time-frequency resource blocks.

27. An apparatus comprising:
at least one processor and at least one memory including a computer program code, wherein the at least one memory and the computer program code are configured, with the at least one processor, to cause the apparatus to perform at least the following:
buffering, in a buffer element, soft data information of a transmitted radio resource block composed of a plurality of resource block parts per resource block part if retransmission of the transmitted radio resource block is requested for decoding the radio resource block,
acquiring decoding performance information for the buffered soft data information of the transmitted radio resource block per resource block part, and
selectively discarding and keeping, in the buffer element, the buffered soft data information of the transmitted radio resource block per resource block part based on the acquired decoding performance information prior to combining, per resource block part, soft data information of the retransmitted radio resource block with buffered soft data information of the transmitted radio resource block for decoding the radio resource block.

28-40. (canceled)

41. An apparatus comprising:
at least one processor and at least one memory including a computer program code, wherein the at least one memory and the computer program code are configured, with the at least one processor, to cause the apparatus to perform at least the following:
collecting information indicative of decoding performance of soft data information of a transmitted radio resource block composed of a plurality of resource block parts per resource block part, which is buffered in a buffer element, if retransmission of the transmitted radio resource block is requested for decoding the radio resource block,
deriving a buffer management decision on the basis of the collected information, said buffer management decision defining, per resource block part, the resource block parts for which the buffered soft data information of the transmitted radio resource block is to be respectively discarded or kept in the buffer element prior to combining, per resource block part, soft data information of the re-transmitted radio resource block with buffered soft data information of the transmitted radio resource block for decoding the radio resource block, and
controlling management of the buffer element on the basis of the derived buffer management decision.

42-53. (canceled)
